(19) United States
(12) Patent Application Publication
(10) Pub. No.: US 2025/0126168 A1
(43) Pub. Date: Apr. 17, 2025

(54) END-USER MONITORING IN DISTRIBUTED LOAD BALANCER

(71) Applicant: VMware LLC, Palo Alto, CA (US)

(72) Inventors: Xiao Liang, Beijing (CN); Bo Lin, Beijing (CN); Dongping Chen, Shanghai (CN); Xinyang Liu, Beijing (CN); Jingchun Jason Jiang, Beijing (CN); Yi Zeng, Beijing (CN); Donghai Han, Beijing (CN)

(21) Appl. No.: 18/510,366

(22) Filed: Nov. 15, 2023

(30) Foreign Application Priority Data
Oct. 17, 2023 (CN) 2023124840

(51) Int. Cl. H04L 67/1008; H04L 67/1017

(52) U.S. Cl. CPC H04L 67/1008; H04L 67/1017

(57) ABSTRACT

Some embodiments of the invention provide a method of performing end-user monitoring. At a health monitor that executes on a first host computer along with a client machine and a load balancer, to monitor health of a set of two or more servers that are candidate servers for processing packets from the client machine, the method exchanges health monitoring messages with each server in the set of servers to assess health of the servers in the set. At the health monitor, the method provides health data expressing health of the servers to the load balancer to use in determining how to distribute packets from the client machine between the servers in the set of servers.

### BACKGROUND

Today, the vast majority of load balancing services use centralized monitors (e.g., centralized health monitors) for detecting the availability of servers behind the load balancers. FIG. 1 conceptually illustrates an example of such a centralized health monitor architecture of a distributed load balancer. The centralized monitor 150 is an independent module that operates separately on the host computer 114 at a location not related to the location of the distributed load balancer instance 120, which operates on a host computer 110 along with client virtual machines (VMs) 130 and 135, and not related to the location of the backend server VMs 140 and 145 on the host computer 112.

The centralized health monitor 150 periodically detects the statuses of backend server VMs 140-145 (e.g., by periodically collecting health data associated with availability of the servers), and reports this data to a centralized controller or network manager 105 (e.g., one or more control plane servers and/or management plane servers) that has a whole view of load balancer configurations. The centralized manager 105 uses the health monitoring results reported by the health monitor 150 to remove any unhealthy servers from a server selection pool used by the load balancer 120 and to update a configuration of the load balancer 120.

However, the result from the health monitor 150 only reflects the data flow between backend server VMs 140-145 and the health monitor 150, and as such, the centralized manager 105 is not aware of whether the client can actually reach a backend server. Additionally, the centralized health monitor 150 is too coarse-grained to optimize the service experience of each user, and while users can detect the status of servers with the help of third-party tools, they cannot integrate with the distributed load balancer to let the distributed load balancer instance intelligently select servers. Furthermore, the centralized manager 105 is responsible for removing unhealthy backend servers, but does so through a configuration that is sent globally to each distributed load balancer instance, which is inaccurate as these “unhealthy” servers may not be unhealthy for all clients (e.g., only one client may be affected), and the complexity of cloud topology determines that user traffic still may not reach a well-functioning server due to network issues (e.g., loss of connection, high latencies, etc.) and/or other issues occurring.

The distributed load balancers lack effective health monitors from end to end, which can affect the ability of these distributed load balancers to select good servers for each user (e.g., for each client VM). By far, most of the centralized health monitors only provide a very rough report to the centralized manager, which then implements global changes based on these rough reports. As a result, servers that are only unhealthy for some clients are removed altogether, thus reducing the number of available servers across all clients and impacting both network performance and end-user experience. A better health monitoring solution is needed.

### BRIEF SUMMARY

Some embodiments of the invention provide a method of performing end-user monitoring. The method is performed at a health monitor that executes on a first host computer along with a client machine and a load balancer, to monitor health of a set of two or more servers that are candidate servers for processing packets from the client machine. At the health monitor, the method exchanges health monitoring messages (e.g., probe packets) with each server in the set of servers to assess health of the servers in the set. The method then provides, at the health monitor, health data expressing health of the servers to the load balancer to use in determining how to distribute packets from the client machine between the servers in the set of servers.

In some embodiments, the client machines are client virtual machines (VMs), and the servers in the set of servers are server VMs. The load balancer, client machine, and health monitor of some embodiments execute on a set of virtualization software (e.g., a hypervisor) of the first host computer. In some embodiments, the health monitor is a health monitor service of the load balancer, while in other embodiments, the health monitor is deployed to the set of virtualization software as a separate module from the load balancer (e.g., a separate VM, separate container, separate pod, etc.).

The health monitor of some embodiments exchanges health monitoring messages with the servers in the server set as part of proactive monitoring of the servers. In some embodiments, the health monitor performs the proactive monitoring by sending probe messages to each server in the set of servers, and monitoring response times from each server in the set of servers. In addition to the proactive monitoring, the health monitor of some embodiments also performs passive monitoring by monitoring response times of the servers in the set of servers to packets sent from the client machine. In some embodiments, when a threshold number of response times associated with a particular server in the set of servers exceed a timeout period defined for response times, the health monitor then provides health data expressing health of the servers to the load balancer indicating the particular server is unhealthy.

In some embodiments, for example, the health data includes a health status of each server in the set of servers that indicates that the server is healthy, or that the server is unhealthy (e.g., when the threshold number of response times exceed the timeout period). In response to an indication that a particular server is unhealthy, the load balancer removes the particular server from the set of servers for the client machine, and does not distribute packets from the client machine to the particular server after it has been removed, according to some embodiments.

The client machine in some embodiments is a first client machine and the set of servers is a first set of servers, and the first host computer also executes a second client machine that uses a second set of servers. In some such embodiments, the health monitor exchanges health monitoring messages with each server in the second set of servers to assess health of the servers in the second set, and provides health data expressing health of these servers to the load balancer to use in determining how to distribute packets from the second client machine between the servers in the second set of servers. The load balancer, in some embodiments, uses the health data provided for the first and second sets of servers to independently determine how to modify (1) a distribution of the flows from the first client machine among the first set of servers and (2) a distribution of the flows from the second client machine among the second set of servers.

In some embodiments, before the particular server is removed from the first set of servers, the first and second servers are the same set of servers (i.e., each server in the first set is also included in the second set). After the particular server is removed from the first set of servers, in some of these embodiments, the particular server is still included in the second set of servers (i.e., the first set of servers is different than the second set of servers after removal of the particular server from the first set). In other words, the second set of servers for the second client machine are not impacted by changes to the first set of servers for the first client machine, and the load balancer continues to distribute packets from the second client machine to the second set of servers including the particular server. In some embodiments, the health monitor determines after a period of time (e.g., based on one or more criteria being met) that the health status of the particular server for the first client machine is again healthy. Based on the updated health status, the load balancer of some embodiments adds the particular server back into the first set of servers for the first client machine.

The load balancer of some embodiments stores a health status matrix that represents (1) the health status of each server in the first set of servers for the first client machine, and (2) the health status of each server in the second set of servers for the second client machine. In some embodiments, before the particular server is removed from the first server set, the health status for each server in the first and second sets is indicated as healthy in the health status matrix, and after the particular server has been removed from the first set, the health status of the particular machine for the first client machine is indicated in the health status matrix as unhealthy, while the health status of the particular machine for the second client machine is indicated as healthy.

In some embodiments, the load balancer distributes packets from the first client machine to the first set of servers, and from the second client machine to the second set of servers according to a server selection policy defined for the load balancer. Examples of server selection policies of some embodiments include, but are not limited to, IP hash, weighted least connection, least connection, weighted round robin, and round robin.

The servers in the first and second sets of servers, in some embodiments, include first and second server machine instances (e.g., server VM instances) that provide a particular service for the first and second client machines. In some embodiments, the particular service is a first portion (e.g., a video service) of a whole service that also includes a second portion (e.g., an advertisement service) that is provided by third and fourth server machine instances executing on a third host computer. In some of these embodiments, the load balancer on the first host computer is a first distributed load balancer (DLB) instance and the health monitor is a first health monitor, while a second DLB instance and second health monitor execute on the second host computer along with the first and second server machine instances to monitor network connections associated with the first and second server machine instances on the second host computer and the third and fourth server machine instances on the third host computer and distribute packets from the first and second server machine instances to the third and fourth server machine instance.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 conceptually illustrates an example of a current centralized health monitor architecture of a distributed load balancer.

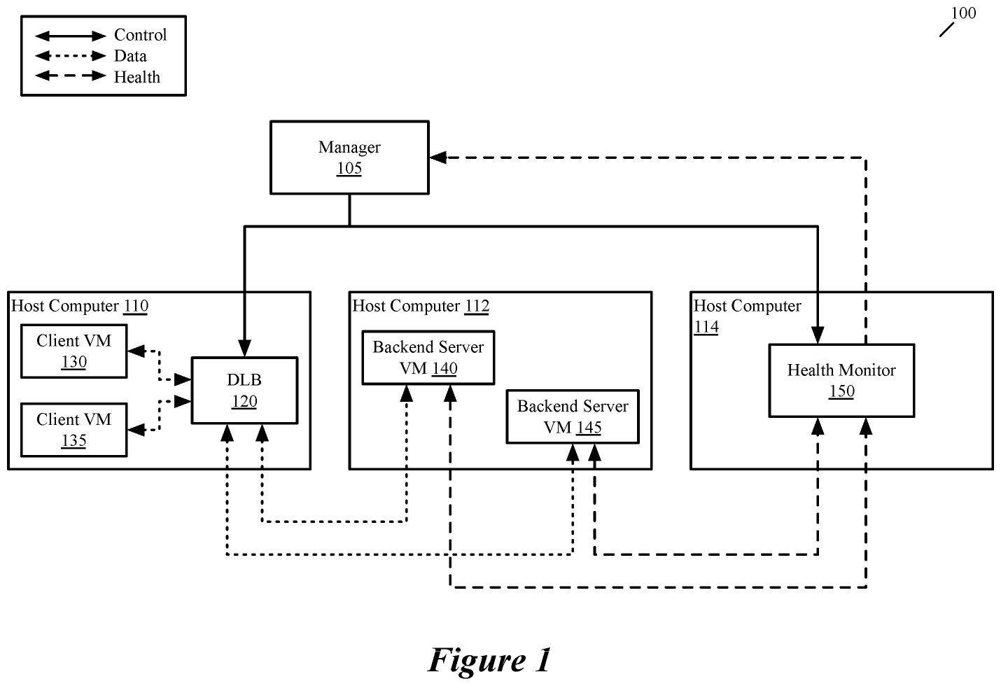

FIG. 2 conceptually illustrates an example architecture diagram of a new architecture for end-user monitoring of some embodiments.

FIG. 3 illustrates an example of a matrix of some embodiments that is stored inside the DLB instance and represents the server status for each client.

FIG. 4 conceptually illustrates an architecture diagram in which health monitors of some embodiments detect network connection failures between clients and servers.

FIG. 5 conceptually illustrates an architecture diagram of some embodiments in which a health monitor reports that a network connection has recovered.

FIG. 6 conceptually illustrates a process performed in some embodiments by a client-side DLB instance that includes a health monitor to load balance packet flows between a set of client machines and a set of server machines.

FIG. 7 conceptually illustrates an architecture diagram of some embodiments in which end-user monitoring is used to find a better route with a well-calculated timeout parameter for a whole service that is provided by multiple components distributed across multiple host computers.

FIG. 8 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method of performing end-user monitoring. The method is performed at a health monitor that executes on a first host computer along with a client machine and a load balancer, to monitor health of a set of two or more servers that are candidate servers for processing packets from the client machine. At the health monitor, the method exchanges health monitoring messages (e.g., probe packets) with each server in the set of servers to assess health of the servers in the set. The method then provides, at the health monitor, health data expressing health of the servers to the load balancer to use in determining how to distribute packets from the client machine between the servers in the set of servers.

In some embodiments, the client machines are client virtual machines (VMs), and the servers in the set of servers are server VMs. The load balancer, client machine, and health monitor of some embodiments execute on a set of virtualization software (e.g., a hypervisor) of the first host computer. In some embodiments, the health monitor is a health monitor service of the load balancer, while in other embodiments, the health monitor is deployed to the set of virtualization software as a separate module from the load balancer (e.g., a separate VM, separate container, separate pod, etc.).

The health monitor of some embodiments exchanges health monitoring messages with the servers in the server set as part of proactive monitoring of the servers. In some embodiments, the health monitor performs the proactive monitoring by sending probe messages to each server in the set of servers, and monitoring response times from each server in the set of servers. In addition to the proactive monitoring, the health monitor of some embodiments also performs passive monitoring by monitoring response times of the servers in the set of servers to packets sent from the client machine. In some embodiments, when a threshold number of response times associated with a particular server in the set of servers exceed a timeout period defined for response times, the health monitor then provides health data expressing health of the servers to the load balancer indicating the particular server is unhealthy.

In some embodiments, for example, the health data includes a health status of each server in the set of servers that indicates that the server is healthy, or that the server is unhealthy (e.g., when the threshold number of response times exceed the timeout period). In response to an indication that a particular server is unhealthy, the load balancer removes the particular server from the set of servers for the client machine, and does not distribute packets from the client machine to the particular server after it has been removed, according to some embodiments.

The client machine in some embodiments is a first client machine and the set of servers is a first set of servers, and the first host computer also executes a second client machine that uses a second set of servers. In some such embodiments, the health monitor exchanges health monitoring messages with each server in the second set of servers to assess health of the servers in the second set, and provides health data expressing health of these servers to the load balancer to use in determining how to distribute packets from the second client machine between the servers in the second set of servers. The load balancer, in some embodiments, uses the health data provided for the first and second sets of servers to independently determine how to modify (1) a distribution of the flows from the first client machine among the first set of servers and (2) a distribution of the flows from the second client machine among the second set of servers.

In some embodiments, before the particular server is removed from the first set of servers, the first and second servers are the same set of servers (i.e., each server in the first set is also included in the second set). After the particular server is removed from the first set of servers, in some of these embodiments, the particular server is still included in the second set of servers (i.e., the first set of servers is different than the second set of servers after removal of the particular server from the first set). In other words, the second set of servers for the second client machine are not impacted by changes to the first set of servers for the first client machine, and the load balancer continues to distribute packets from the second client machine to the second set of servers including the particular server. In some embodiments, the health monitor determines after a period of time (e.g., based on one or more criteria being met) that the health status of the particular server for the first client machine is again healthy. Based on the updated health status, the load balancer of some embodiments adds the particular server back into the first set of servers for the first client machine.

The load balancer of some embodiments stores a health status matrix that represents (1) the health status of each server in the first set of servers for the first client machine, and (2) the health status of each server in the second set of servers for the second client machine. In some embodiments, before the particular server is removed from the first server set, the health status for each server in the first and second sets is indicated as healthy in the health status matrix, and after the particular server has been removed from the first set, the health status of the particular machine for the first client machine is indicated in the health status matrix as unhealthy, while the health status of the particular machine for the second client machine is indicated as healthy.

In some embodiments, the load balancer distributes packets from the first client machine to the first set of servers, and from the second client machine to the second set of servers according to a server selection policy defined for the load balancer. Examples of server selection policies of some embodiments include, but are not limited to, IP hash, weighted least connection, least connection, weighted round robin, and round robin.

The servers in the first and second sets of servers, in some embodiments, include first and second server machine instances (e.g., server VM instances) that provide a particular service for the first and second client machines. In some embodiments, the particular service is a first portion (e.g., a video service) of a whole service that also includes a second portion (e.g., an advertisement service) that is provided by third and fourth server machine instances executing on a third host computer. In some of these embodiments, the load balancer on the first host computer is a first distributed load balancer (DLB) instance and the health monitor is a first health monitor, while a second DLB instance and second health monitor execute on the second host computer along with the first and second server machine instances to monitor network connections associated with the first and second server machine instances on the second host computer and the third and fourth server machine instances on the third host computer and distribute packets from the first and second server machine instances to the third and fourth server machine instance.

In some embodiments, the method described above is a service detection method from the perspective of users that is provided through end-user monitoring. The service detection method focuses more on whether each independent user can obtain a desired service, according to some embodiments. For the service detection method, a health-monitoring module (e.g., health monitor) is located on the user side (i.e., client side), in some embodiments, such as the health monitoring module of the first DLB instance on the first host computer described above. In some embodiments, the health-monitoring module is deployed to the DLB instance, which executes on a set of virtualization software (e.g., hypervisor) of host computer. In some embodiments, the health-monitoring module is deployed on the DLB instance (e.g., the health-monitoring module is a health monitoring service executed by the DLB instance), while in other embodiments, the health-monitoring module is deployed as a separate module outside of the DLB and on the set of virtualization software (e.g., deployed as a separate VM, separate pod, separate container, etc.).

End-user monitoring has a different intention compared to centralized monitoring techniques that are typically used. In some embodiments, end-user monitoring (e.g., through the health-monitoring module) monitors what an end user receives from a service. This information is then used to help the DLB instance utilize backend servers (i.e., backend servers that provide services) with better performance. Because the DLB is distributed, the manager (e.g., a network management server) has the ability to know the location of the clients, which is more intuitive with the health monitor being placed on the client side (e.g., as a component of the DLB instance).

Results from the health-monitoring module of some embodiments are used to dynamically adjust the DLB's server selection in order to enable each user to obtain the highest success rate possible for that user (e.g., by altering the server selection pool on a per-client machine basis). Due to fine-grained monitoring achieved by the client-side health-monitoring module, the client-side health-monitoring module is associated with several advantages, in some embodiments. For example, in some embodiments, the fine-grained monitoring leads to more accurate detection (i.e., a few failures will not affect the whole), and faster switching (e.g., traffic can be quickly redirected to new backend servers if the server pool is using an IP hash algorithm).

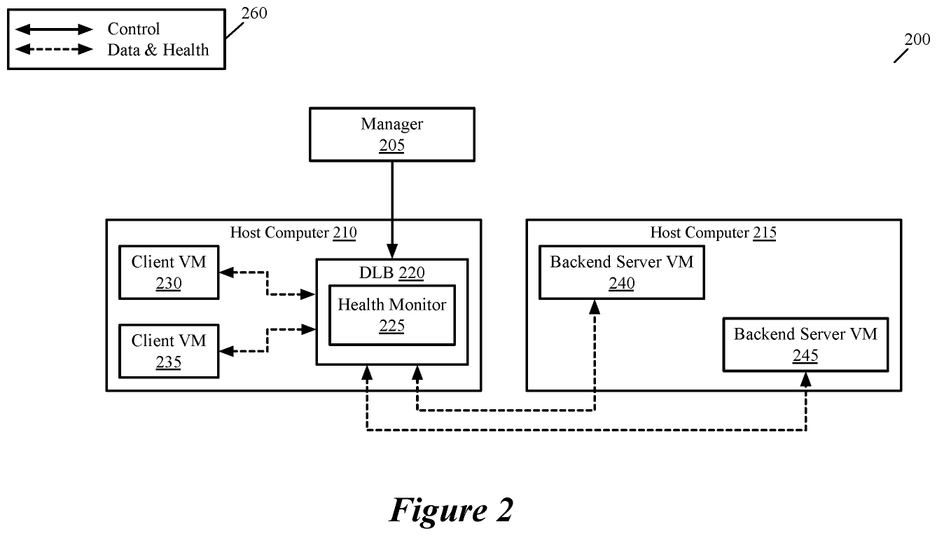

FIG. 2 conceptually illustrates an example architecture diagram 200 of a new architecture for end-user monitoring of some embodiments. In this new architecture, the health monitor is placed in the DLB on the client side. As shown, the diagram 200 includes a manager 205 (e.g., a network management server), and host computers 210 and 215. The host computer 210 includes client VMs 230 and 235, and a DLB instance 220 in which a health monitor 225 is located. The host computer 215 includes backend server VMs 240 and 245. As indicated by the legend 260, solid lines in the diagram 200 represent control plane traffic, while dashed lines represent data plane traffic and health monitoring traffic. The client VMs are the source VMs that send packets to the VIP (virtual Internet protocol) addresses of the backend server VMs (i.e., that send packets with destination IP addresses set to the VIP addresses of the backend server VMs).

A distributed load balancer is realized on each hypervisor (e.g., a set of virtualization software executing on a host computer) where load balancing workloads are deployed, ensuring traffic is load balanced on each hypervisor in a distributed manner, according to some embodiments. The DLB instance 220 is a process running on a hypervisor (not shown) of the host computer 210 to function as a distributed load balancer to load balance traffic between the client VMs 230 and 235 on the host computer 210 and the backend server VMs 240 and 245 on the host computer 215. Additional details regarding distributed load balancers are described in U.S. Pat. No. 10,320,679, filed on Dec. 1, 2014, and titled “Inline Load Balancing”. U.S. Pat. No. 10,320,679 is incorporated herein by reference.

The health monitor 225 works together with DLB instance 220 on the host computer 210. While a user interacts with backend servers 240 and 245 on the host computer 215, the health monitor 225 inspects the responses. If no response is received, or if responses repeatedly indicate that the backend server 240 and/or 245 is not able to connect, the health monitor 225 reports the status of the offending backend server 240 and/or 245 to DLB instance 220. In some embodiments, these functions (i.e., inspecting traffic to and from the VMs 230 and 235 and reporting health statuses to the DLB instance 220) of the health monitor 225 are referred to as passive monitoring. The health monitor 225 of some embodiments only handles errors associated with layer 4 (L4) and below. Also, while the DLB instance 220 is illustrated as a single DLB instance that provides load balancing services for both of the client VMs 230 and 235, in other embodiments, a separate DLB instance is deployed to the host computer 210 for each of the client VMs 230 and 235.

In addition to the passive monitoring performed by the health monitor 225, in some embodiments the health monitor 225 also performs proactive monitoring during which the health monitor 225 proactively sends packets (e.g., probe packets) to the backend servers 240 and 245 to perform health checks on the backend servers and the connections to these servers. These probe packets, in some embodiments, are TCP packets or UDP packets. The health monitor 225 needs a source IP address and source port in order to send these proactive probes. The source IP address used by the health monitor 225 must have the ability to reach the network of the backend servers, and as such, it is not practical to preserve a source address from the subnet of each client. Accordingly, the health monitor 225 of some embodiments uses the client IP address as the source IP address for these proactive probes.

For the source port, the health monitor 225 of some embodiments uses a reserved port to perform the proactive monitoring. In some embodiments, if the client (e.g., a client machine) uses the same port as the reserved port, then the reserved port is replaced with a different port that is then reserved for the health checking. When available and possible, well-known ports (i.e., <1024) are utilized internally, in some embodiments, in order to avoid conflict. The end-user monitoring architecture stays the same regardless of whether the health monitor 225 is operating in passive monitoring mode or proactive monitoring mode, according to some embodiments.

In some embodiments, a half-passive health-checking solution is also utilized by the health monitor 225. For example, in some embodiments, a health check probe is used to detect the current status of unhealthy backend servers. While a source IP address and a source port are needed, the health monitor 225 of some embodiments uses an IP address of a client machine as the source IP address, and uses a random port as the source port. Because no data is sent to the unhealthy backend server, the probe packets do not get mixed up with actual traffic of the client machine to which the source IP address used by the health monitor 225 belongs.

The probe packets sent by the health monitor 225, in some embodiments, are sent at a particular interval (e.g. in seconds) configured for the health monitor 225. In some embodiments, the health check interval is identical for each backend server, while in other embodiments, different health check intervals are defined for different backend servers. In addition to the health check intervals, the health monitor 225 of some embodiments is also configured with a healthy threshold count that defines a number of consecutive health checks that are indicative of a healthy server required before an unhealthy server is considered a healthy server. Similarly, the health monitor 225 is also configured with an unhealthy threshold count that defines a number of consecutive health checks that are indicative of an unhealthy server required before a healthy server is considered an unhealthy server.

In some embodiments, the health monitor 225 is also configured with a base check interval that defines a base wait time before a new packet flow from a client machine is sent to an unhealthy server (i.e., while the unhealthy server is still being used to service packet flows from the client machines). Each failure increases the wait time, in some embodiments. Additionally, a maximum check interval is also configured for the health monitor 225 and defines the maximum wait time before a new packet flow from a client machine is sent to an unhealthy server. In some embodiments, the maximum wait time is utilized until the unhealthy threshold count is met.

Each DLB instance 220, in some embodiments, stores a matrix that represents the statuses of each backend server 240 and 245 for each client (e.g., each client VM 230 and 235). In some embodiments, the matrix includes a row for each client (e.g., each client VM 230 and 235) and a column for each server (e.g., backend server VMs 240 and 245). When the status of a server changes (e.g., when connections to the server fail), and the health monitor 225 reports the updated status to the DLB instance 220, the DLB instance 220 updates the matrix to reflect the status change for the reported server.

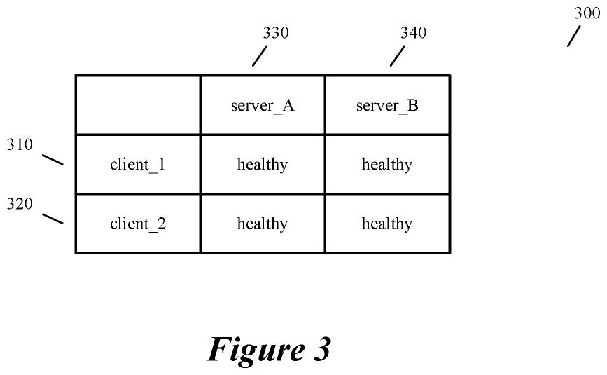

FIG. 3 illustrates an example of a matrix 300 of some embodiments that is stored inside the DLB instance and represents the server status for each client. As shown, the matrix 300 includes a row 310 for “client_1”, a row 320 for “client_2”, a column 330 for “server_A”, and a column 340 for “server_B”. In this example, the status of “server_A” for both “client_1” and “client_2” is indicated as healthy, as is the status of “server_B” for both “client_1” and “client_2”.

When the DLB instance receives a status report from the health monitor that the datapath between a client and a server is not working (e.g., the connection has failed, the latency has surpassed a latency threshold for the client-server combination, etc.), the DLB instance updates the matrix to reflect the status change, and subsequently adjusts its server selection policy based on the updated matrix. Three main aspects of this method of end-user monitoring of some embodiments include placing the health monitor at the client side, configuring the health monitor to report results to the DLB instance, and configuring the DLB instance to independently make decisions to adjust its server selection policy.

In some embodiments, each DLB instance is configured to report health statuses to the manager 205. The manager 205 aggregates the health statuses reported by all DLB instances, in some embodiments, and displays the aggregated results for viewing by a user (e.g., through a UI (user interface) provided by the management plane). When all reports indicate a particular server is healthy, the particular server is considered good, in some embodiments. When some, but not all, reports indicate a particular server is unhealthy, in some embodiments, the particular server is considered problematic. Lastly, in some embodiments, when all reports indicate a particular server is unhealthy, the particular server is considered down.

In some embodiments, the traffic associated with the client VMs 230 and 235, and the probing traffic sent by the health monitor 225, is sent to the backend servers 240 and 245 via an intervening network fabric. For example, in some embodiments, the intervening network fabric includes a private network (e.g., an MPLS (multiprotocol label switching) network), or includes one or more public networks, such as the Internet and/or one or more networks of one or more public clouds. In other embodiments, the intervening network fabric includes a combination of public and private networks (such as those mentioned above). The intervening network fabric of some embodiments includes wired or wireless connections, various network forwarding elements (e.g., switches, routers, etc.), etc. The wired or wireless connections are formed over links. The links of some embodiments include wired and wireless links, point-to-point links, broadcast links, multipoint links, point-to-multipoint links, public links, and private links (e.g., MPLS (multiprotocol label switching) links). The wired links of some embodiments can include, e.g., coaxial cables and fiber optic cables.

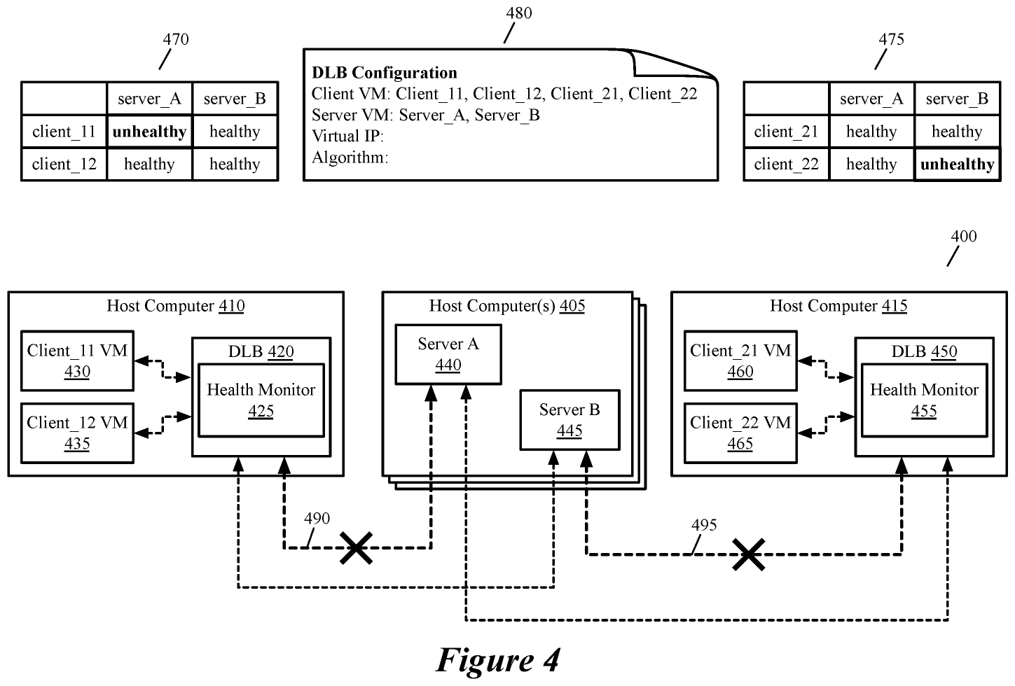

FIG. 4 conceptually illustrates an architecture diagram 400 in which health monitors of some embodiments detect network connection failures between clients and servers. As indicated by the DLB configuration 480, the client VMs (i.e., client-side devices) in this example include “Client_11”, “Client_12”, “Client_21”, and “Client_22”, while the server VMs (i.e., server-side devices) include “Server_A” and “Server_B”. While the DLB configuration 480 does not specify any particular load balancing algorithm, examples of the load balancing algorithms configured for a DLB instance, in some embodiments, include IP hash, weighted least connection, least connection, weighted round robin, round robin, etc.

In some embodiments, for example, the DLB configuration 480 specifies a weighted round robin algorithm is configured for a DLB instance such that the DLB instance distributes to each machine based on probabilities specified by weight values assigned to the machines (i.e., as opposed to round robin in which flows are distributed to each machine with equal probability). When the DLB instance is distributing, for instance, ten (10) flows to a set of four (4) machines (e.g., four servers), the DLB instance of some embodiments distributes these ten flows based on 2, 3, 3, 2, such that two flows are sent to the first machine, three flows are sent to the second machine, three flows are sent to the third machine, and two flows are sent to the fourth machine. After receiving health monitoring data associated with each of the four machines from the health monitor indicating, for example, that the first machine is overutilized and the fourth machine is underutilized, the DLB instance of some such embodiments modifies its weighted round robin to decrease a weight associated with the first machine and increase a weight associated with the fourth machine. Accordingly, the DLB instance subsequently uses the modified weighted round robin algorithm to distribute a next set of ten flows based on, for instance, 1, 3, 3, 3, such that one flow is sent to the first machine, three flows are sent to the second machine, three flows are sent to the third machine, and three flows are sent to the fourth machine, thereby lessening the load on the first machine and increasing the load on the fourth machine.

As shown, the architecture diagram 400 includes host computers 410, and 415 for executing client VMs, as well as one or more host computers 405 for executing one or more sets of backend server VMs, such as the servers 440 and 445, that provide one or more services to the client VMs on the host computers 410 and 415. Host computer 410 executes client VMs 430 and 435 (i.e., “Client_11” VM 430 and “Client_12” VM 435), as well as a DLB instance 420 in which a health monitor 425 is deployed. Host computer 415 executes client VMs 460 and 465 (i.e., “Client 21” VM 460 and “Client_22” VM 465), as well as a DLB instance 450 in which a health monitor 455 is deployed.

The health monitor 425 is responsible for monitoring the network connections between the client VMs 430 and 435 on the host computer 410 and the servers 440 and 445 on the host computer 405, while the health monitor 455 is responsible for monitoring the network connections between the client VMs 460 and 465 on the host computer 415 and the servers 440 and 445 on the host computer(s) 405. The health monitors 425 and 455 respectively report the statuses of the network connections between the client VMs on their respective host computers 410 and 415 and the servers 440 and 445 on the host computer(s) 405 to their respective DLB instances 420 and 450.

Each DLB instance 420 and 450 uses the health statuses of the network connections to the servers 440 and 445 that are reported by their respective health monitors 425 and 455 to generate respective matrices 470 and 475. The health monitor 425 on host computer 410 reports that the data flow 490 between client VM 430 and server A 440 is down, and the health monitor 455 on host computer 415 reports that the data flow 495 between client VM 465 and server B 445 is down.

Based on these reports, each DLB instance 420 and 450 on each host computer 410 and 415 updates their respective matrix 470 and 475 to reflect the updates health statuses for the network connections associated with these data flows. For example, the matrix 470 stored by the DLB instance 420 indicates the network connection between client VM 430 and server A 440 as unhealthy, while each other network connection in the matrix 470 is indicated as a healthy network connection. Similarly, the matrix 475 stored by the DLB instance 450 indicates the network connection between client VM 465 and server B 445 as unhealthy, while each other network connection in the matrix 475 is indicated as a healthy network connection.

In some embodiments, updating the matrices 470 and 475 also results in server selection policies for the affected client VMs 430 and 465 to be updated (e.g., to prevent the unavailable/failed network connections from being selected). Accordingly, based on the updated matrices 470 and 475, server A 440 is not selected by the DLB instance 420 as the server for the next request (e.g., next packet) from client VM 430 as it is specified as “unhealthy”, and server B 445 is not selected by the DLB instance 450 as the server for the next request from client VM 465 as it is specified as “unhealthy”. In some embodiments, if the backend server selection pool for a client VM includes only unhealthy backend servers, the DLB instance 450 routes requests from that client VM to all of those unhealthy backend servers, regardless of their health status.

The changes to the server selection policies for the affected client machines 430 and 465 do not affect server selection policies for client VM 435 or client VM 460. In some embodiments, traffic associated with client VM 435 and client VM 460 is still redirected and distributed to both of the servers 440 and 445. During this period, the manager (not shown) in some embodiments is not required to participate in the server selection decision-making performed by the DLB instances 420 and 450. The configuration is still the same, and only the server selection policy in different DLB instances 420 and 450 varies (i.e., for the affected client VMs).

In some embodiments, adjustments to server selection policies based on the reported health statuses of the network connections by the health monitors leads to advantages such as faster switching ability. For example, if a user chooses the IP_HASH algorithm for selecting among the backend servers, a client request will always be redirected to the same server. In some embodiments, the end-user monitoring via the health monitors on the DLBs detects the network issue from the client to the server, and in some embodiments, the client is re-hashed to a new server.

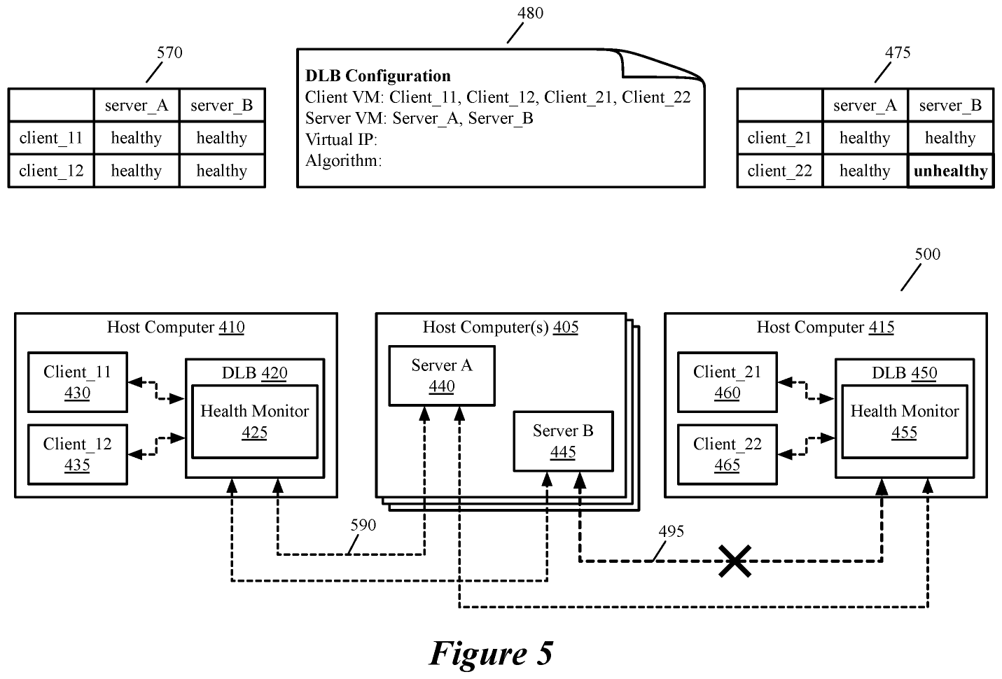

FIG. 5 conceptually illustrates an architecture diagram 500 of some embodiments in which a health monitor reports that a network connection has recovered. As shown, based on a report from the health monitor 425 on host computer 410 that the network connection 590 between client VM 430 and server A 440 has been restored, the client VM 430 is again able to access the service from server A 440 via the connection 590.

Based on the reporting by the health monitor 425, the DLB instance 420 on host computer 410 updates the matrix 570 to reflect that the network connection 590 between client VM 430 and server A 440 has recovered and is “healthy”, and brings server A 440 back into the server selection pool for the client VM 430 (e.g., by adjusting the server selection policy again for the client VM 430). While the network connection 590 has recovered, the network connection 495 between the client VM 465 on host computer 415 and the server B 445 on the host computer 405 is still down, as illustrated. As such, the matrix 475 of the DLB instance 450 still indicates the connection 495 as unhealthy.

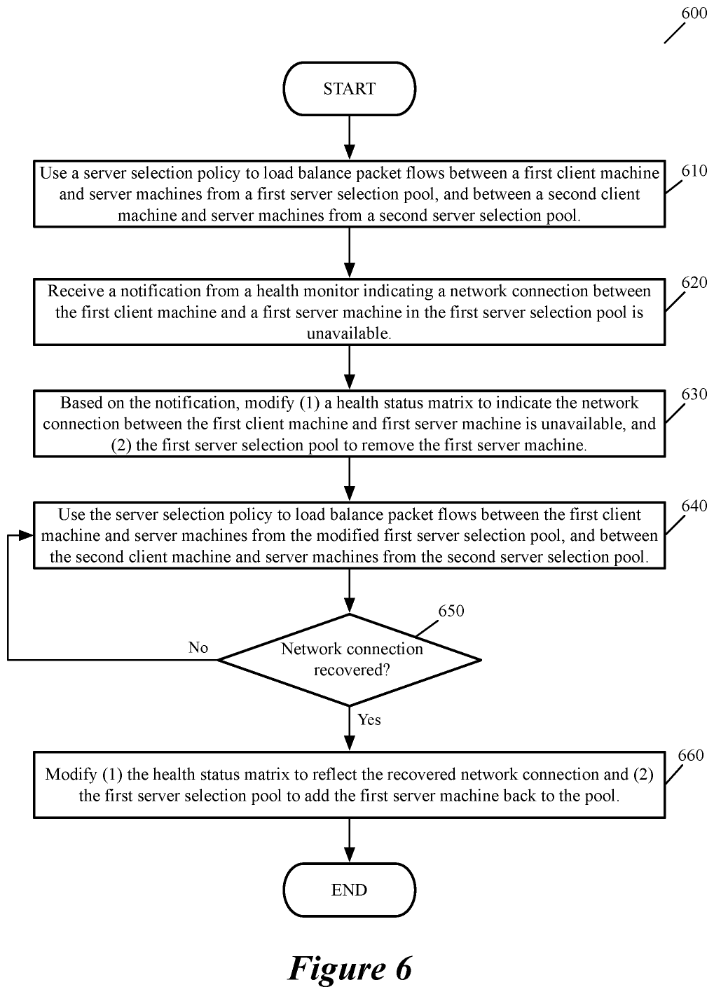

FIG. 6 conceptually illustrates a process 600 performed in some embodiments by a client-side DLB instance that includes a health monitor to load balance packet flows between a set of client machines and a set of server machines. The process 600 will be described below with references to the diagrams 400 and 500. The process 600 starts when the DLB instance uses (at 610) a server selection policy to load balance packet flows between a first client machine and server machines from a first server selection pool, and between a second client machine and server machines from a second server selection pool. In some embodiments, the server selection policy specifies a load balancing algorithm to be used by the DLB instance to load balance respective packet flows from the first and second machines across the respective first and second server selection pools.

In some embodiments, the first and second server selection pools initially include the same set of server machines (i.e., server machines in the first server selection pool are the same server machines as are in the second server selection pool). For instance, in the diagram 400 described above, the server selection pool for the client VM 430 on the host computer 410 includes servers 440 and 445, and the server selection pool for the client VM 435 on the host computer 410 includes servers 440 and 445 (i.e., the same servers as the server selection pool of the client VM 430).

The process 600 receives (at 620) a notification from a health monitor indicating a network connection between the first client machine and a first server machine in the first server selection pool is unavailable. For example, the health monitor 425 in the diagram 400 notifies its DLB instance 420 that the network connection between the client VM 430 and the server A 440 has gone down, and the health monitor 455 notifies its DLB instance 450 that the network connection between client VM 465 and the server B 445 has gone down. In some embodiments, a network connection that is still up and running will be reported by the health monitor as unhealthy due to circumstances such as response times that exceed a timeout period, and, in some embodiments, such reported issues are treated by the DLB instance in the same way as downed, failed, or otherwise unavailable connections.

Based on the notification, the process 600 modifies (at 630) a health status matrix to indicate the network connection between the first client machine and first server machine is unavailable, and the first server selection pool to remove the first server machine. The matrices 470 and 475, for instance, both identify an unhealthy network connection. The matrix 470 indicates the network connection between the client VM 430 and the server A 440 is unhealthy, while the matrix 475 indicates the network connection between the client VM 465 and the server B 445 is unhealthy.

The process 600 uses (at 640) the server selection policy to load balance packet flows between the first client machine and server machines from the modified first server selection pool, and between the second client machine and server machines from the second server selection pool. Because the server selection pool for each client VM 430, 435, 460, and 465 initially includes only two servers—server A 440 and server B 445—when the DLB instance 420 removes the server A 440 from the server selection pool for client VM 430, and when the DLB instance 450 removes the server B 445 from the server selection pool for client VM 465, each of these server selection pools is left with a single server.

As a result, the server selection policy configured for each DLB instance 420 and 450 will result in the remaining server VM for each client VM 430 or 465 (e.g., server B 445 is the only server left in the pool for client VM 430, and server A 440 is the only server left in the pool for client VM 465). The server selection pools for the other client VMs 435 and 460 are unaffected by changes to the pools for client VMs 430 and 465, and the DLB instances 420 and 450 continue to distribute traffic from client VMs 435 and 460 across both servers 440 and 445.

The process 600 determines (at 650) whether the network connection has recovered. The health monitor of the DLB instance continues to monitor network connections that have been deemed unhealthy, and when these network connections recover and become available, the health monitor notifies its DLB instance of the status change. For instance, the network connection between client VM 430 and server A 440 is down in the diagram 400 (e.g., as indicated by the crossed-out dashed line 490), but has recovered in the diagram 500 (e.g., as indicated by the dashed line 590). When the network connection has not yet recovered, the process 600 returns to 640 to continue to use the server selection policy to load balance packet flows between the first client machine and server machines from the modified first server selection pool, and between the second client machine and server machines from the second server selection pool.

When the network connection has recovered, the process 600 transitions to modify (at 660) the health status matrix to reflect the recovered network connection, and the first server selection pool to add the first server machine back to the pool. The health matrix 570, for example, indicates the connection between the client VM 430 and server A 440 is a healthy connection based on the recovered network connection 590. Following 660, the process 600 ends.

In some embodiments, a whole service is provided by several components that, in some embodiments, execute on two or more separate host computers. In some such embodiments, each component is both a server and a client, and each host computer on which these components execute includes a DLB instance with a health monitor for monitoring the client-server connections and performing server selection. In some embodiments, when multiple network connections fail at any location in a network, such as the example illustrated by the diagram 400, or when multiple network connections fail at multiple points of the network, the success rate of client requests decreases exponentially.

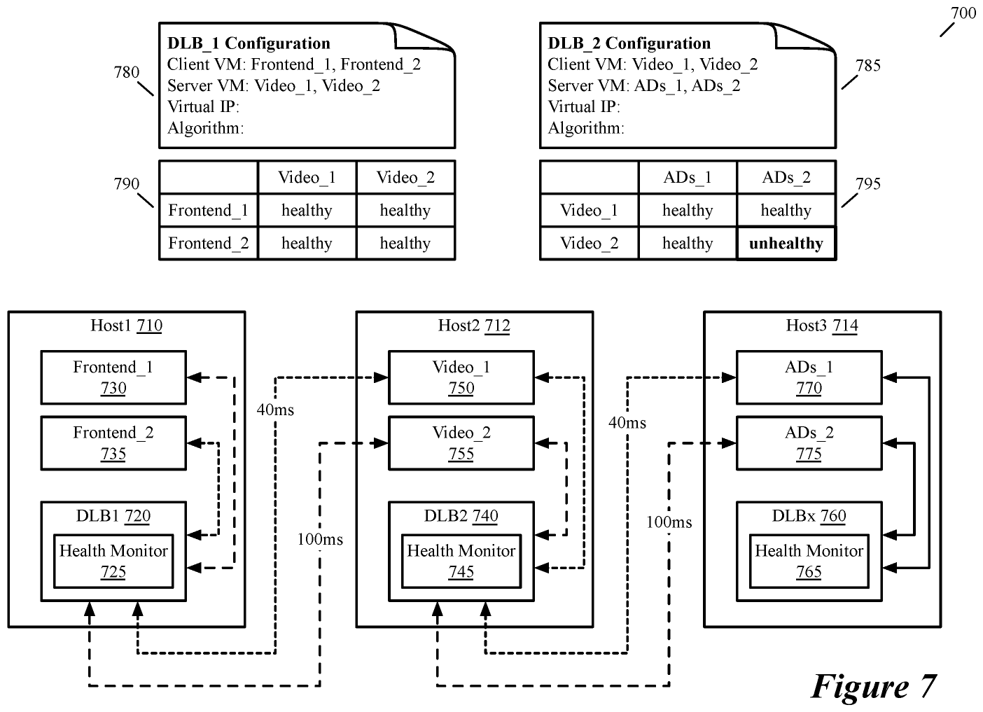

FIG. 7 conceptually illustrates an architecture diagram 700 of some embodiments in which end-user monitoring is used to find a better route with a well-calculated timeout parameter for a whole service that is provided by multiple components distributed across multiple host computers. As shown, the diagram 700 includes three host computers 710, 712, and 714. The host computer 710 includes frontend server VMs 730 and 735 (e.g., “Frontend_1” 730 and “Frontend_2” 735), as well as a DLB instance 720 that includes a health monitor 725. The host computer 712 includes video server VMs 750 and 755 (e.g., “Video_1” 750 and “Video_2” 755), and a DLB instance 740 that includes a health monitor 745. Lastly, the host computer 714 includes ad server VMs 770 and 775 (e.g., “ADs_1” 770 and “ADs_2” 775), and a DLB instance 760 that includes a health monitor 765.

In this example, there are two DLB configurations 780 and 785 for the DLB instances 720 and 740, respectively. The DLB configuration 780 for the DLB instance 720 specifies client VMs as “Frontend_1” 730 and “Frontend_2” 735, and specifies server VMs as “Video_1” 750 and “Video_2” 755. The DLB configuration 785 for the DLB instance 740 specifies client VMs as “Video_1” 750 and “Video_2” 755, and specifies server VMs as “ADs_1” 770 and “ADs_2” 775. As such, the health monitor 725 of the DLB instance 720 monitors the network connections between the VMs 730 and 735 on the host computer 710 (i.e., the client VMs of these network connections that are the source of packets sent to destination VIP addresses of the server VMs) and the VMs 750 and 755 on the host computer 712 (i.e., the server VMs of these network connections that are associated with the destination VIP addresses), while the health monitor 745 of the DLB instance 740 monitors the network connections between the VMs 750 and 755 on the host computer 712 (i.e., the client VMs of these network connections that are the source of packets sent to destination VIP addresses) and the VMs 770 and 775 on the host computer 714 (i.e., the server VMs of these network connections that are associated with the destination VIP addresses).

All of the server VMs 750-755 on host computer 712 and 770-775 on host computer 714 are functioning, but have large differences in response times (i.e., 40 ms compared to 100 ms), as shown. In some embodiments, each DLB instance 720 and 740 sets a timeout in their respective health monitors 725 and 745 in order to filter out some of the routes that are take too much time on the network (e.g., the routes associated with 100 ms response times). For example, in some embodiments, the DLB instances 720 and 740 each set timeouts of 80 ms, and based on these timeouts, filter out the routes to video server VM 755 and ad server 775, respectively, due to these routes having response times of 100 ms, which exceeds the 80 ms timeouts.

In some embodiments, when a server's response time exceeds the timeout, or exceeds the timeout more than a threshold number of times, the DLB instance on the client side updates its matrix to indicate the network connection associated with the exceed timeout is “unhealthy” to prevent this server from being selected for future packet flows. The health monitors of some embodiments continue to monitor these connections, in some embodiments, and if the response times for these servers and associated network connections fall below the timeout (e.g., a certain number of consecutive response times fall below the timeout), the health monitors notify their DLB instances, which, in some embodiments, update their matrices accordingly (e.g., to indicate the network connection is “healthy”) and re-add the servers to the server selection pool.

Benefits to and advantages of the end-user monitoring methods described above include (1) that the decision making is delegated to each DLB instance, and thus fine-grained decisions are made for the connection between each client and the server, (2) that better performance is achieved even if the network topology is complicated or if traffic is transferred multiple times between services, and (3) that user experience is improved through the use of a user perspective monitor.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

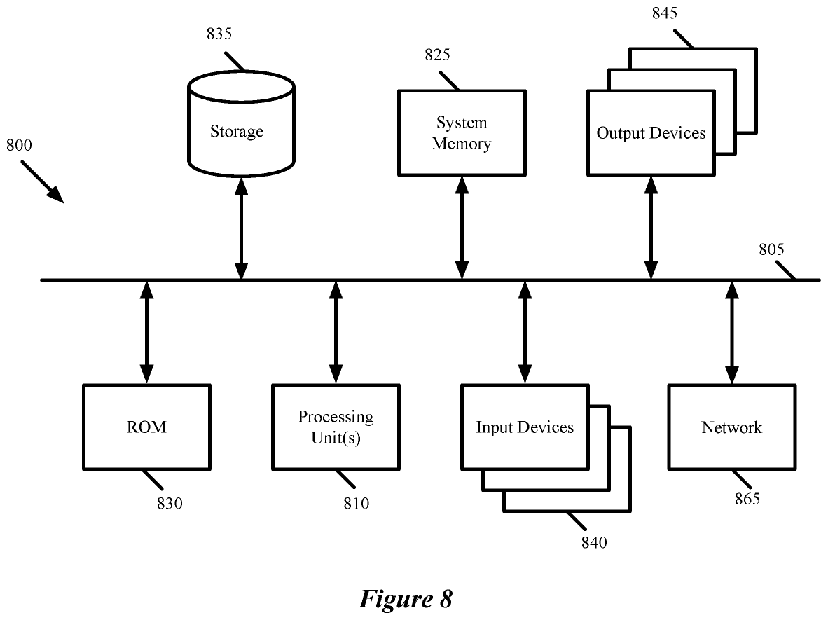

FIG. 8 conceptually illustrates a computer system 800 with which some embodiments of the invention are implemented. The computer system 800 can be used to implement any of the above-described hosts, controllers, gateway, and edge forwarding elements. As such, it can be used to execute any of the above described processes. This computer system 800 includes various types of non-transitory machine-readable media and interfaces for various other types of machine-readable media. Computer system 800 includes a bus 805, processing unit(s) 810, a system memory 825, a read-only memory 830, a permanent storage device 835, input devices 840, and output devices 845.

The bus 805 collectively represents all system, peripheral, and chipset buses that communicatively connect the numerous internal devices of the computer system 800. For instance, the bus 805 communicatively connects the processing unit(s) 810 with the read-only memory 830, the system memory 825, and the permanent storage device 835.

From these various memory units, the processing unit(s) 810 retrieve instructions to execute and data to process in order to execute the processes of the invention. The processing unit(s) 810 may be a single processor or a multi-core processor in different embodiments. The read-only-memory (ROM) 830 stores static data and instructions that are needed by the processing unit(s) 810 and other modules of the computer system 800. The permanent storage device 835, on the other hand, is a read-and-write memory device. This device 835 is a non-volatile memory unit that stores instructions and data even when the computer system 800 is off. Some embodiments of the invention use a mass-storage device (such as a magnetic or optical disk and its corresponding disk drive) as the permanent storage device 835.

Other embodiments use a removable storage device (such as a floppy disk, flash drive, etc.) as the permanent storage device. Like the permanent storage device 835, the system memory 825 is a read-and-write memory device. However, unlike storage device 835, the system memory 825 is a volatile read-and-write memory, such as random access memory. The system memory 825 stores some of the instructions and data that the processor needs at runtime. In some embodiments, the invention's processes are stored in the system memory 825, the permanent storage device 835, and/or the read-only memory 830. From these various memory units, the processing unit(s) 810 retrieve instructions to execute and data to process in order to execute the processes of some embodiments.

The bus 805 also connects to the input and output devices 840 and 845. The input devices 840 enable the user to communicate information and select commands to the computer system 800. The input devices 840 include alphanumeric keyboards and pointing devices (also called “cursor control devices”). The output devices 845 display images generated by the computer system 800. The output devices 845 include printers and display devices, such as cathode ray tubes (CRT) or liquid crystal displays (LCD). Some embodiments include devices such as touchscreens that function as both input and output devices 840 and 845.

Finally, as shown in FIG. 8, bus 805 also couples computer system 800 to a network 865 through a network adapter (not shown). In this manner, the computer 800 can be a part of a network of computers (such as a local area network (“LAN”), a wide area network (“WAN”), or an Intranet), or a network of networks (such as the Internet). Any or all components of computer system 800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of performing end-user monitoring, the method comprising:
at a health monitor that executes on a first host computer along with a client machine and a load balancer, to monitor health of a set of two or more servers that are candidate servers for processing packets from the client machine:
exchanging health monitoring messages with each server in the set of servers to assess health of the servers in the set; and
providing health data expressing health of the servers to the load balancer to use in determining how to distribute packets from the client machine between the servers in the set of servers.

2. The method of claim 1, wherein exchanging the health monitoring messages comprises performing proactive monitoring by sending probe messages to each server in the set of servers and monitoring response times of response packets from each server in the set of servers.

3. The method of claim 2 further comprising performing passive monitoring by monitoring response times of servers in the set of servers to packets sent by the client machine.

4. The method of claim 3, wherein when a threshold number of response times associated with a particular server in the set of servers exceed a timeout period defined for response times, providing health data expressing health of the servers to the load balancer comprises providing health data to the load balancer indicating the particular server is unhealthy.

5. The method of claim 1, wherein the health data expressing health of the servers comprises, for each server in the set of servers, a health status that indicates that the server is a healthy server or that the server is an unhealthy server, wherein the load balancer uses the health data to add a server to or remove a server from the set of servers.

6. The method of claim 5, wherein the load balancer removes a particular server from the set of servers when the health status for the particular server indicates that the particular server is unhealthy, wherein the load balancer does not distribute packets from the client machine to the particular server after the particular server is removed from the set of servers.

7. The method of claim 6, wherein the client machine is a first client machine and the set of servers is a first set of servers, wherein the first host computer further executes a second client machine that uses a second set of servers, the method further comprising:
at the health monitor:
exchanging health monitoring messages with each server in the second set of servers to assess health of the servers in the second set; and
providing health data expressing health of the servers to the load balancer to use in determining how to distribute packets from the second client machine between the servers in the second set of servers.

8. The method of claim 7, wherein the load balancer uses the health data provided for the first and second sets of servers to independently determine how the load balancer modifies (i) a distribution of the flows from the first client machine among the first set of servers and (ii) a distribution of the flows from the second client machine among the second set of servers.

9. The method of claim 8, wherein before the particular server is removed from the first set of servers, the first set of servers and the second set of servers are a same set of servers, wherein after the particular server is removed from the first set of servers, the particular server is still included in the second set of servers.

10. The method of claim 9, wherein the load balancer stores a health status matrix representing (i) the health status of each server in the first set of servers for the first client machine, and (ii) the health status of each server in the second set of servers for the second client machine.

11. The method of claim 10, wherein:
before removing the particular server from the first set of servers, (i) the health status for each server in the first set of servers for the first client machine is indicated as healthy in the health status matrix, and (ii) the health status for each server in the second set of servers for the second client machine is indicated as healthy in the health status matrix; and
after removing the particular server from the first set of servers, the load balancer modifies the health status matrix to update the health status for the particular server for the first client machine, wherein the modified health status matrix (i) indicates the particular server is unhealthy for the first client machine, and (ii) indicates the particular server is healthy for the second client machine.

12. The method of claim 6 further comprising providing additional health data for the particular server in the set of servers, the additional health data comprising an updated health status for the particular server that indicates that the particular server is healthy, wherein based on the updated health status for the particular server, the load balancer adds the particular server back to the set of servers for the client machine.

13. The method of claim 6, wherein the load balancer distributes packets from the client machine between servers in the set of servers according to a server selection policy defined for the load balancer.

14. The method of claim 13, wherein the server selection policy comprises one of IP hash, weighted least connection, least connection, weighted round robin, and round robin.

15. The method of claim 1, wherein the set of servers comprises first and second server machine instances executing on a second host computer, wherein the first and second server machine instances provide a particular service for the client machine.

16. The method of claim 15, wherein the particular service is a first portion of a whole service, wherein the whole service further comprises a second portion that is provided by third and fourth server machine instances executing on a third host computer.

17. The method of claim 16, wherein the load balancer is a first distributed load balancer (DLB) instance and the health monitor is a first health monitor, wherein a second DLB instance executes on the second host computer along with a second health monitor that monitors network connections associated with the first and second server machine instances on the second host computer and the third and fourth server machine instances on the third host computer that are candidates for processing packets from the first and second server machine instances.

18. The method of claim 17, wherein the first portion of the whole service provided by the first and second server machine instances comprises a video service, and the second portion of the whole service provided by the third and fourth server machine instances comprises an advertisement service.

19. The method of claim 1, wherein the load balancer, client machine, health monitor execute on a set of virtualization software of the first host computer.

20. The method of claim 1, wherein the health monitor is a health monitoring service of the load balancer.
